(19) United States
(12) Patent Application Publication
(10) Pub. No.: US 2012/0014744 A1
(43) Pub. Date: Jan. 19, 2012

(54) Support Head Assembly

(76) Inventor: CHIEN-TING LIN, Santa Fe Springs, CA (US)

(21) Appl. No.: 13/183,407

(22) Filed: Jul. 14, 2011

(30) Foreign Application Priority Data
Jul. 14, 2010 (CN) 201020258026.3

(51) Int. Cl. F16C 11/10

(52) U.S. Cl. 403/91

(57) ABSTRACT

A support head assembly includes a main body, a tooth disk unit, a tooth disk cap, a button, a button cap, and a spring. The tooth disk cap and the button cap are assembled on the main body. Two ends of the spring are respectively secured on a securing post of the tooth disk unit and a securing post of the tooth disk cap, and abutted against therebetween, such that a tooth disk of the tooth disk unit is engaged with a first tooth slot of the main body and a second tooth slot of the tooth disk cap. The tooth disk of the tooth disk unit can be disengaged from the first tooth slot of the main body and fully received in the second tooth slot of the tooth disk cap by pressing the button and further the tooth disk unit to compress the spring, so as to allow the support head assembly to be made angle adjustment according to the desires.

### BACKGROUND OF THE INVENTION

1. Field of the Invention

The present invention relates to a connection unit mounted on a stand, and more particular to a support head assembly.

2. The Prior Arts

In photographing, radio and television, movie making, and live broadcast industries, many photographing, image capturing, and illuminating apparatuses are required. These apparatuses need professional stands during use. According to structural features, conventional support head assemblies of the stands can be categorized as several types each having a single installation hole or a plurality of installation holes, for example three installation holes. Most of the support head assemblies are not able to be directly made angle adjustment according to actual desires. The angle adjustment has to be carried out by additional disassembling and assembling operations, thereby being inconvenient in use. Additionally, the conventional support head assemblies need to have a sleeve joint for being mounted on the stands. Even though a few of support head assemblies are able to be made angle adjustment, the angle adjustment can only be achieved by special or complicated mechanical structures, such as mounting a handle at a location of a vertical post or a horizontal rod of the stands far from the mounted position of the support head assembly. Therefore, it is desired to provide an improved support head assembly.

### SUMMARY OF THE INVENTION

A primary objective of the present invention is to provide a support head assembly without needing an additional sleeve joint for being mounted on a stand and capable of easily and conveniently making angle adjustment.

To achieve the above-mentioned objective, a support head assembly according to the present invention comprises a tooth disk unit, a button cap, a button, a tooth disk cap, and a spring. The main body has a head part and a base part. The base part is provided with a smooth slot, a first tooth slot, an axle hole, and a button recess. The smooth slot is adjacent to the first tooth slot, and is communicated with the button recess through the axle hole. The tooth disk unit has a tooth disk, an axle, an axle head, and a securing post. The axle of the tooth disk unit is inserted through the axle hole of the main body, and the tooth disk of the tooth disk unit is received and engaged with in the first tooth slot. The button cap has a button hole, a button retainer. The button has a fastening seat and a press part on the fastening seat. The fastening seat is provided with an axle head hole on the bottom of the fastening seat. After the completion of assembling, the button is received in the button recess of the main body, and the axle head of the tooth disk unit is engaged in the axle head hole of the button. Meanwhile, the fastening seat of the button is abutted against the button retainer of the button cap, and the press part is protruded from the button hole of the button cap for being operated by a user. The tooth disk cap has a second tooth slot, a securing post in and beneath second tooth slot, and a smooth post. The second tooth slot is defined inside the smooth post. The smooth post of the tooth disk cap is engaged with the smooth slot of the main body; thereby the second tooth slot of the tooth disk cap is aligned with the first tooth slot of the main body. The spring has a first end and a second end. The first end of the spring is abutted against the securing post of the tooth disk unit, and the second end of the spring is abutted against the securing post of the tooth disk cap; thereby the tooth disk of the tooth disk unit is received and engaged in the first tooth slot of the main body and the second tooth slot of the tooth disk cap when the spring is not compressed.

Compared with the conventional arts, the support head assembly of the present invention can be made angle adjustment more flexible and convenient, be fastened by a bolt on a stand, and does not need any conventional sleeve joint for being mounted on the stand.

### BRIEF DESCRIPTION OF THE DRAWINGS

The present invention will be apparent to those skilled in the art by reading the following detailed description of a preferred embodiment thereof, with reference to the accompanying drawings, in which:

FIG. 1 is a perspective view of a support head assembly according to a preferred embodiment of the present invention;

FIG. 2 is an exploded perspective view of the support head assembly according to the embodiment of the present invention;

FIG. 3 is another exploded perspective view of the support head assembly of the present invention taken from a different viewing direction;

FIG. 4 is a cross sectional view of the support head assembly of the present invention showing a pressing operation on a button; and

FIG. 5 is a perspective view of the support head assembly of the present invention showing an angle adjustment.

### DETAILED DESCRIPTION OF THE PREFERRED EMBODIMENT

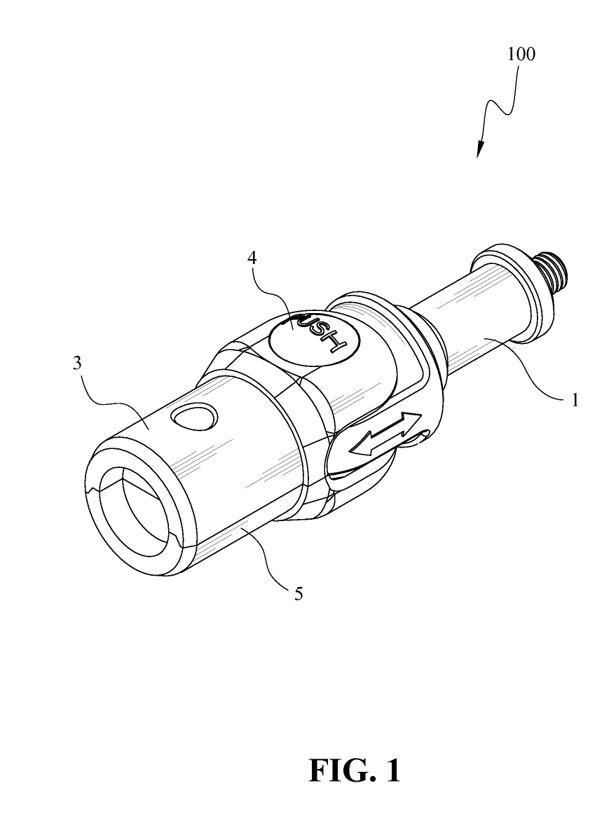

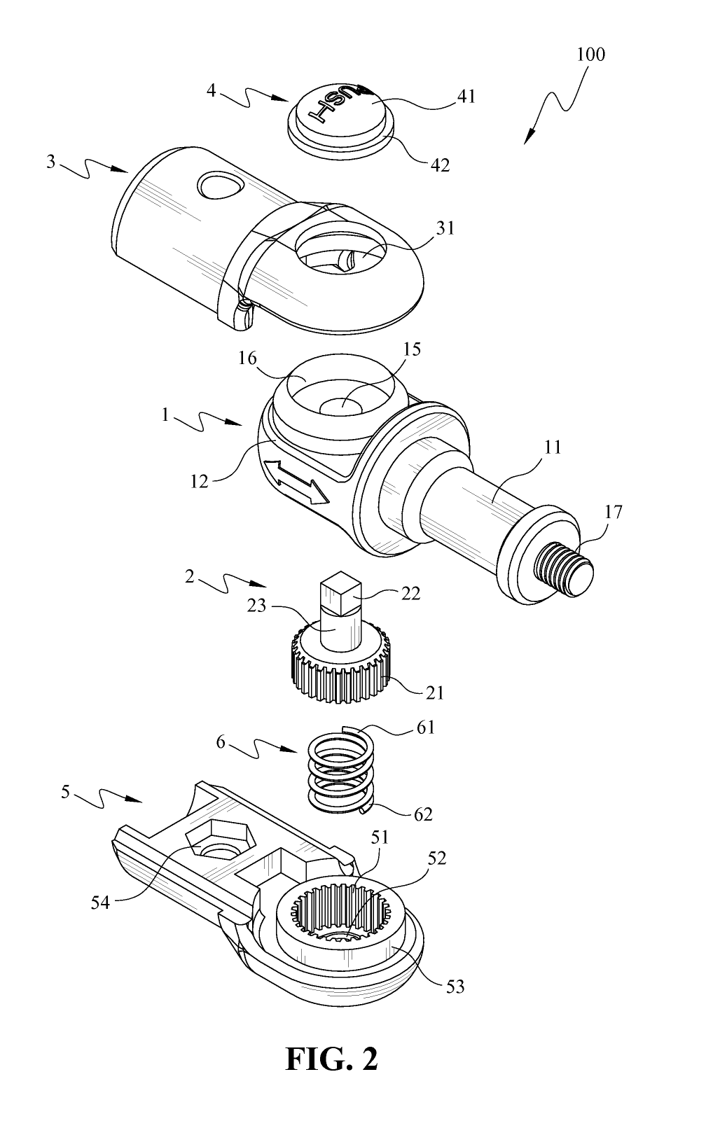

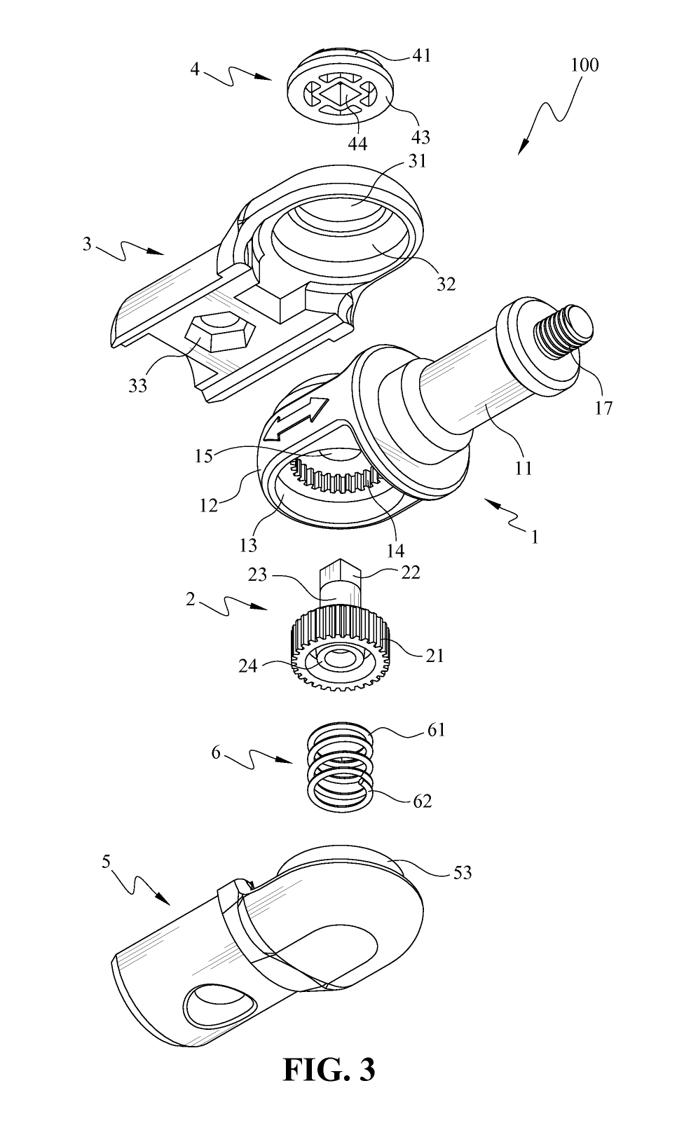

Please refer to FIGS. 1-3, which respectively are a perspective view, and two exploded perspective views taken from different viewing directions, showing a support head assembly 100 according to an embodiment of the present invention. The support head assembly 100 includes a main body 1, a tooth disk unit 2 (served as a rotation control member), a button cap 3, a button 4, a tooth disk cap 5, and a spring 6. The button cap 3 and the tooth disk cap 5 are assembled to a cap unit in the embodiment of the present invention. The support head assembly of the present invention can be mounted on a horizontal rod or a vertical post of a stand, and can be used to connect with a device, such as an image capturing device, photographing device, illumination device, or other devices which can be mounted on the stand. The features of the present invention are that the support head assembly can be made angle adjustment more flexible and convenient, be fastened by a bolt on the stand, and does not need any conventional sleeve joint for being mounted on the stand. Each of the main components and their assembling are illustrated as follows.

The main body 1 has a head part 11 and a base part 12. The base part 12 is provided with a smooth slot 13, a first tooth slot 14, an axle hole 15, and a button recess 16. The smooth slot 13 is adjacent to the first tooth slot 14 (served as a first female mounting part), and is communicated with the button recess 16 through the axle hole 15. The head part 11 has a connection part 17 for being connected with a device, for example an image capturing device, photographing device, or illumination device.

The tooth disk unit 2 has a tooth disk 21 (served as a male mounting part), an axle 23, an axle head 22, and a securing post 24. The axle 23 of the tooth disk unit 2 is inserted through the axle hole 15 of the main body 1, and the tooth disk 21 of the tooth disk unit 2 is received and engaged with in the first tooth slot 14.

The button cap 3 has a button hole 31, a button retainer 32, and a screw nut hole 33. The button 4 has a fastening seat 42 and a press part 41 on the fastening seat 42. The fastening seat 42 has a retaining surface 43 on a bottom thereof, and is provided with an axle head hole 44 on the bottom of the fastening seat 42. After the completion of assembling, the button 4 is received in the button recess 16 of the main body 1, and the axle head 22 of the tooth disk unit 2 is engaged in the axle head hole 44 of the button 4. Meanwhile, the fastening seat 42 of the button 4 is abutted against the button retainer 32 of the button cap 3, and the press part 41 is protruded from the button hole 31 of the button cap 3 for being operated by a user.

The tooth disk cap 5 has a second tooth slot 51 (served as a second female mounting part), a securing post 52 in and beneath second tooth slot 51, a smooth post 53, and a screw nut hole 54. The second tooth slot 51 is defined inside the smooth post 53. The smooth post 53 of the tooth disk cap 5 is engaged with the smooth slot 13 of the main body 1; thereby the second tooth slot 51 of the tooth disk cap 5 is aligned with the first tooth slot 14 of the main body 1.

The spring 6 (served as a resilient member) has a first end 61 and a second end 62. The first end 61 of the spring 6 is abutted against the securing post 24 of the tooth disk unit 2, and the second end 62 of the spring 6 is abutted against the securing post 52 of the tooth disk cap 5; thereby the tooth disk 21 of the tooth disk unit 2 is received and engaged in the first tooth slot 14 of the main body 1 and the second tooth slot 51 of the tooth disk cap 5 when the spring 6 is not compressed.

The assembling of the support head assembly 100 according to the present invention is illustrated as follows. Firstly, the axle 23 of the tooth disk unit 2 is inserted through the axle hole 15 of the main body 1, and the tooth disk 21 of the tooth disk unit 2 is received and engaged with in the first tooth slot 14 of the main body 1. The first end 61 of the spring 6 is secured on the securing post 24 of the tooth disk unit 2, and the smooth post 53 of the tooth disk cap 5 is inserted and engaged in the smooth slot 13 of the main body 1. At this moment, the second tooth slot 51 of the tooth disk cap 5 is completely aligned with the first tooth slot 14 of the main body 1. In the engagement between the smooth post 53 of the tooth disk cap 5 and the smooth slot 13 of the main body 1, the second end 62 of the spring 6 has to be precisely secured on the securing post 52 of the tooth disk cap 5. Then the axle head 22 inserting through the base part 12 of the main body 1 is precisely engaged in the axle head hole 44 at the center of the retaining surface 43 of the button 4. Finally, the button cap 3 is precisely assembled to the tooth disk cap 5 by a bolt inserted through the screw nut hole 33 of the button cap 3 and the screw nut hole 54 of the tooth disk cap 5. After the completion of assembling, the press part 41 of the button 4 is protruded from the button hole 31 of the button cap 3.

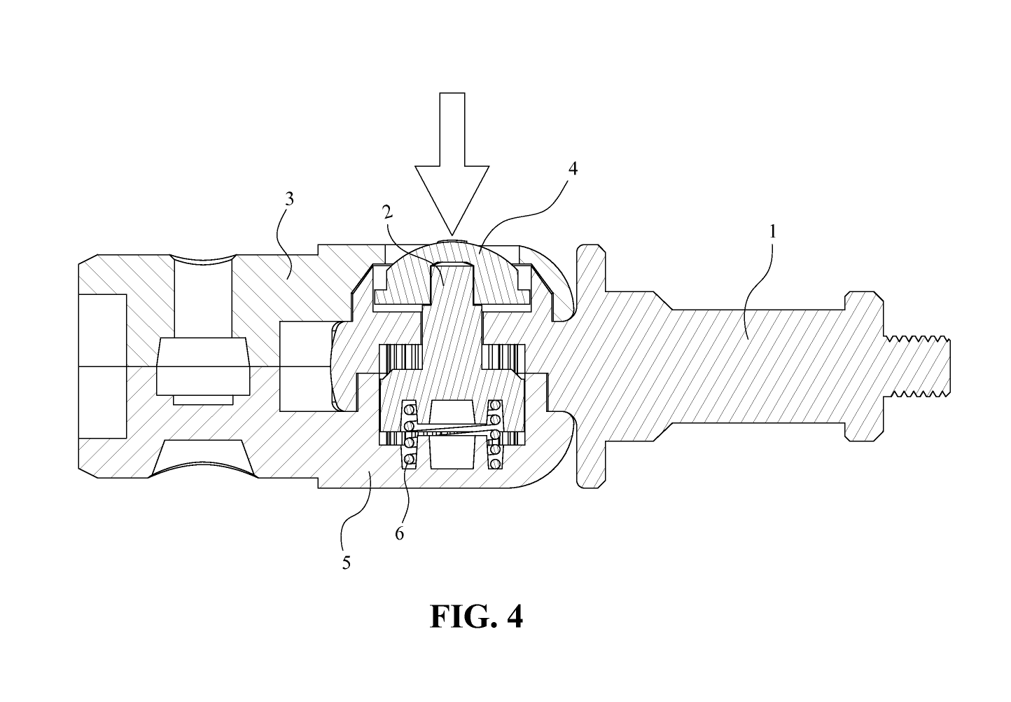

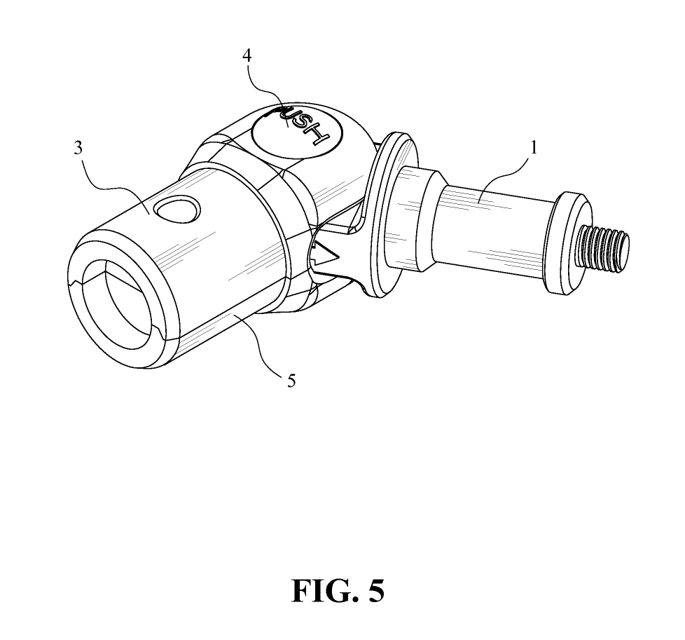

Please refer to FIG. 4 and FIG. 5, which are a cross sectional view of the support head assembly of the present invention showing a pressing operation; and a perspective view of the support head assembly of the present invention showing an angle adjustment, respectively. When the spring 6 is not compressed by an external force, the tooth disk 21 of the tooth disk unit 2 is pushed into the first tooth slot 14 of the main body 1 by the spring 6; thereby the support head assembly can not be made angle adjustment. When a force is applied on the press part 41 of the button 4, the force pushes the tooth disk 21 of the tooth disk unit 2 into the second tooth slot 51 of the tooth disk cap 5; thereby the main body 1 is disengaged from the tooth disk 21 of the tooth disk unit 2 and can then be made angle adjustment in a direction around the tooth disk unit 2 (see FIG. 5).

Moreover, the structural design of the screw nut hole 33 of the button cap 3 and the screw nut hole 54 of the tooth disk cap 5 is to allow a bolt to be screwed in the screw nut hole for achieving the purpose of fastening the support head assembly 100 on a horizontal rod or a vertical post of a stand, and avoiding the entire support head assembly to be discarded due to the failure of thread tapping process or the wearing of inner thread of a screw hole.

According to the present invention, the support head assembly 100 has an angle adjustment function, a small volume, and is easy and convenient to operate in use by pressing a button to make angle adjustment according to the desires.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A support head assembly comprising:
a main body having a first female mounting part;
a cap unit, pivotally assembled on the main body and having a second female mounting part aligned with the first female mounting part; and
a rotation control member having a male mounting part engaged with the first female mounting part of the main body and the second female mounting part of the cap unit, the rotation control member being stood against the cap unit through a resilient member, wherein the male mounting part of the rotation control member is able to be disengaged from the first female mounting part of the main body by pressing the resilient member, so as to allow the main body to be made angle adjustment around the rotation control member.

2. The support head assembly according to claim 1, wherein the cap unit is composed of a button cap and a tooth disk cap assembled together.

3. The support head assembly according to claim 1, wherein the main body includes a head part and a base part.

4. The support head assembly according to claim 3, wherein the head part of the main body further includes a connection part for being connected with a device.

5. The support head assembly according to claim 1, wherein the rotation control member is a tooth disk unit, and the male mounting part of the rotation control member is a tooth disk.

6. The support head assembly according to claim 5, wherein the first female mounting part of the main body is a first tooth slot, and the second female mounting part of the cap unit is a second tooth slot.

7. The support head assembly according to claim 1, wherein the rotation control member is further connected with a button.

8. The support head assembly according to claim 1, wherein the resilient member is a spring.
